(19) United States
(12) Patent Application Publication
(10) Pub. No.: US 2026/0058374 A1
(43) Pub. Date: Feb. 26, 2026

(54) FSS for Enhancing Antenna Radiation Efficiency

(71) Applicant: HUAWEI TECHNOLOGIES CO., LTD., Shenzhen (CN)

(72) Inventors: Yinghong Gu, Dongguan (CN); Sucheng Li, Dongguan (CN); Jiang Wang, Chengdu (CN); Jianping Li, Dongguan (CN); Tao Pu, Shanghai (CN); Lei Li, Shanghai (CN); Jia Lv, Shanghai (CN); Feng Peng, Shanghai (CN)

(73) Assignee: HUAWEI TECHNOLOGIES CO., LTD., Shenzhen (CN)

(21) Appl. No.: 19/371,636

(22) Filed: Oct. 28, 2025

Related U.S. Application Data
(63) Continuation of application No. PCT/CN2024/090156, filed on Apr. 26, 2024.

(30) Foreign Application Priority Data
Apr. 28, 2023 (CN) 202310491720.1

(51) Int. Cl. H01Q 15/00; H01Q 1/52

(52) U.S. Cl. CPC H01Q 15/0013; H01Q 1/526

(57) ABSTRACT

An FSS unit includes a radiation assembly, a receiving assembly, and a transmission assembly that are stacked and spaced apart. There is space between the radiation assembly and the receiving assembly. A metal shielding member and a feed network component are located in the space, the metal shielding member is configured to shield at least one of the transmission assembly and the feed network component, and a cavity of the metal shielding member is configured to place the transmission assembly or the feed network component.

### CROSS-REFERENCE TO RELATED APPLICATIONS

This is a continuation of International Patent Application No. PCT/CN2024/090156 filed on Apr. 26, 2024, which claims priority to Chinese Patent Application No. 202310491720.1 filed on Apr. 28, 2023, which are hereby incorporated by reference in their entireties.

### TECHNICAL FIELD

Embodiments of the present disclosure relate to the field of communication technologies, and in particular, to a frequency-selective surface (FSS) unit, an FSS, an antenna, a communication device, and a communication system for enhancing antenna radiation efficiency.

### BACKGROUND

An FSS is a two-dimensional periodic array structure with filtering performance, and exhibits obvious passband or stopband filtering characteristics when interacting with electromagnetic waves. Based on a unique frequency selective characteristic of the frequency selective surface, the frequency selective surface has been widely used in radar antennas, reflectors, polarizers, microwave sensors, spatial filters, and the like.

In a related technology, when the frequency selective surface is applied in the antenna field, an antenna-filter frequency selective surface-antenna architecture is usually used. The frequency selective surface may receive electromagnetic waves sent by one of the antennas, transmit an electromagnetic wave of a specific frequency in the received electromagnetic waves, and effectively filters out an electromagnetic wave of a frequency other than the frequency, to transmit a signal of the specific frequency to the outside. The frequency selective surface may reflect electromagnetic waves sent by the other antenna, to reduce mutual interference between the two antennas.

However, in the related technology, when the frequency selective surface is disposed between the two antennas, if one of the antennas is disposed above the frequency selective surface, a feed network component (for example, a phase shifter) of the antenna usually passes through an outer side of the frequency selective surface and feeds a signal into the antenna. However, the feed network component causes interference to the other antenna disposed below the frequency selective surface, thereby affecting performance of the other antenna disposed below the frequency selective surface.

### SUMMARY

Embodiments of the present disclosure provide an FSS unit (or FSS system), an FSS, an antenna, a communication device, and a communication system, to resolve a problem that operating performance is affected because a feed network component causes interference to another antenna disposed below the FSS unit.

A first aspect of the present disclosure provides an FSS unit. The FSS unit includes a radiation assembly, a receiving assembly, and a transmission assembly that are stacked and spaced apart. The radiation assembly includes a radiator and a first metal layer that are stacked and spaced apart, the receiving assembly includes a receiver and a second metal layer that are stacked and spaced apart, the first metal layer and the second metal layer are located between the radiator and the receiver, one end of the transmission assembly passes through the first metal layer to be electrically connected to the radiator, and the other end of the transmission assembly passes through the second metal layer to be electrically connected to the receiver. The transmission assembly is configured to transmit a signal received by the receiver to the radiator, so that the radiator radiates the received signal to the outside. There is space between the radiation assembly and the receiving assembly. The FSS unit further includes a feed network component and at least one metal shielding member with a cavity, the metal shielding member and the feed network component are located in the space, the metal shielding member is configured to shield at least one of the transmission assembly and the feed network component, and the cavity of each metal shielding member is configured to place the transmission assembly or the feed network component.

If the feed network component is placed outside the space formed between the radiation assembly and the receiving assembly, the feed network component is likely to cause interference to a second antenna array disposed below the FSS unit, affecting radiation efficiency. Therefore, in the present disclosure, the feed network component is disposed inside the space between the radiation assembly and the receiving assembly, and the first metal layer and the second metal layer may spatially shield electromagnetic waves of other frequencies generated by a first antenna array and the second antenna array on two sides from the space, to improve isolation between the first antenna array and the second antenna array. In addition, the feed network component is placed in the space, and coupling between the feed network component and the transmission assembly is likely to affect signal transmission. Therefore, in the present disclosure, the metal shielding member is used to shield the feed network component and the transmission assembly from each other, so that when the feed network component feeds a signal into the first antenna array located above the FSS unit, interference is not likely to be generated between the signal transmitted by the feed network component and the signal transmitted by the transmission assembly, and radiation efficiency of an antenna is also improved.

In a possible implementation, the radiation assembly further includes a first dielectric plate and a second dielectric plate that are stacked and spaced apart, the first dielectric plate has a first surface and a second surface that are opposite to each other, the second dielectric plate has a third surface and a fourth surface that are opposite to each other, and the second surface of the first dielectric plate is opposite to the third surface of the second dielectric plate. The radiator is located on the first dielectric plate, and the first metal layer is located on the third surface or the fourth surface of the second dielectric plate. The feed network component is disposed between the second dielectric plate and the second metal layer. The second dielectric plate may be configured to place the first metal layer. Therefore, after being integrated into a whole, the second dielectric plate and the first metal layer may serve as a ground plate of the radiator in the FSS unit. The first dielectric plate may be configured to place the radiator.

In a possible implementation, the receiving assembly further includes a third dielectric plate and a fourth dielectric plate that are stacked and spaced apart, the third dielectric plate has a fifth surface and a sixth surface that are opposite to each other, the fourth dielectric plate has a seventh surface and an eighth surface that are opposite to each other, and the sixth surface of the third dielectric plate is opposite to the seventh surface of the fourth dielectric plate. The receiver is located on the fourth dielectric plate, and the second metal layer is located on the fifth surface or the sixth surface of the third dielectric plate. The feed network component is disposed between the second dielectric plate and the third dielectric plate.

The third dielectric plate may be configured to place the second metal layer. Therefore, after being integrated into a whole, the third dielectric plate and the second metal layer may serve as a ground plate of the receiver in the FSS unit. The fourth dielectric plate may be configured to place the receiver. In addition, one end of the metal shielding member may penetrate the first dielectric plate and the second dielectric plate, and the other end of the metal shielding member may penetrate the third dielectric plate and the fourth dielectric plate. The metal shielding member may support the second dielectric plate and the third dielectric plate to form space between the second dielectric plate and the third dielectric plate.

In a possible implementation, the metal shielding member is a shielding frame, the shielding frame has one or more cavities, the feed network component is disposed in the cavity of the metal shielding member, and two opposite side surfaces of the shielding frame are provided with openings. The feed network component is located in the cavity of the metal shielding member. The transmission assembly is located outside the cavity. Therefore, the metal shielding member may shield the signal transmitted by the transmission assembly and the signal transmitted by the feed network component from each other. The openings of the shielding frame facilitate installation and maintenance of the feed network component by working personnel.

In a possible implementation, the transmission assembly includes at least one substrate, one end of the substrate penetrates the second dielectric plate and the first dielectric plate, and the other end of the substrate penetrates the third dielectric plate and the fourth dielectric plate. The substrate has two opposite surfaces, a metal sheet is disposed on at least one surface of the substrate, one end of the metal sheet is electrically connected to the receiver, and the other end of the metal sheet is electrically connected to the radiator. When metal sheets are disposed on both opposite surfaces of the substrate, a contact area of an electrical connection between the first dielectric plate and the second dielectric plate may be increased. In addition, because the two surfaces on which the metal sheets are disposed are opposite to each other and isolated, when a connection between a metal sheet on one surface and the first dielectric plate or the second dielectric plate fails, a metal sheet on the other surface may still maintain electrical conduction between the radiator and the receiver, thereby helping improve stability of an electrical connection between the radiator and the receiver.

In a possible implementation, the metal sheet includes an upper metal sheet and a lower metal sheet, and there is a gap between the upper metal sheet and the lower metal sheet. The upper metal sheet and the lower metal sheet are spaced apart, so that an equivalent capacitor may be formed, to implement signal transmission. Impedance matching between the antenna and the transmission assembly may be implemented by adding the capacitor to a transmission path between the receiver and the radiator. When the antenna matches the transmission assembly, a reflected wave is not likely to occur on the transmission assembly, so that a loss on the transmission assembly is reduced, thereby helping improve radiation performance.

In a possible implementation, the metal sheet is disposed on one surface of the substrate, the gap between the upper metal sheet and the lower metal sheet includes at least one horizontal gap and at least one vertical gap, and the horizontal gap communicates with the vertical gap. A structure formed by the horizontal gap and the vertical gap may increase a contact area of coupling transmission between the upper metal sheet and the lower metal sheet, thereby helping improve signal transmission effect.

In a possible implementation, the metal sheet is disposed on each surface of the substrate, and along a length direction of the substrate, the gap of the metal sheet on one surface of the substrate and the gap of the metal sheet on the other surface of the substrate are staggered. The gaps are staggered, so that a contact area of coupling transmission may be effectively increased, to improve signal transmission effect.

In a possible implementation, one end that is of the radiator and that faces the first dielectric plate has at least one first slot that is in a one-to-one correspondence with the at least one substrate, one end of each substrate is inserted into the first slot corresponding to the substrate, and one end of the metal sheet disposed on each of the two surfaces of the substrate is in electrical contact with the radiator. One end that is of the receiver and that faces the fourth dielectric plate has at least one second slot that is in a one-to-one correspondence with the at least one substrate, the other end of each substrate is inserted into the second slot corresponding to the substrate, and the other end of the metal sheet disposed on the substrate is in electrical contact with the receiver. One end of the substrate may be connected to the radiation assembly through the first slot. The other end of the substrate may be connected to the receiving assembly through the second slot.

In a possible implementation, the first metal layer is disposed on the third surface of the second dielectric plate, and the feed network component is disposed on the fourth surface of the second dielectric plate. The transmission assembly penetrates the cavity of the metal shielding member.

The feed network component is located in the space between the radiation assembly and the receiving assembly. Therefore, the feed network component is not likely to cause interference to the second antenna array disposed below the FSS unit, thereby preventing radiation efficiency from being affected. In addition, the metal shielding member may shield the signal transmitted by the transmission assembly, to confine the signal in the cavity. Therefore, interference is not likely to be generated between the feed network component located outside the metal shielding member and the transmission assembly.

In a possible implementation, the metal shielding member is a shielding tube, one end of the shielding tube is connected to the second dielectric plate and the first metal layer, and the other end of the shielding tube is connected to the third dielectric plate and the second metal layer. The shielding tube peripherally surrounds the transmission assembly, to shield the signal transmitted by the transmission assembly, thereby confining the signal in the shielding tube. Therefore, the shielding tube may shield the signal transmitted by the feed network component and the signal transmitted by the transmission assembly from each other, so that the two signals may not interfere with each other.

In a possible implementation, the transmission assembly includes at least one transmission wire, and one end of the transmission wire passes through the shielding tube, the second dielectric plate, and the first dielectric plate to be electrically connected to the radiator. The other end of the transmission wire passes through the third dielectric plate and the fourth dielectric plate to be electrically connected to the receiver. The transmission wire is configured to transmit a signal received by the receiving assembly to the radiation assembly.

In a possible implementation, an orthographic projection of the radiator onto the receiver coincides with the receiver. Therefore, signals received by the FSS unit may correspond to signals radiated by the FSS unit, thereby helping improve performance of the antenna.

In a possible implementation, the radiator is a dipole radiator.

In a possible implementation, the radiator and the receiver each include a plurality of first branches, and the first branches are electrically connected to the transmission assembly.

In a possible implementation, the radiator and the receiver each further include a plurality of second branches that are respectively coupled to the plurality of first branches.

In a possible implementation, the plurality of second branches is symmetrically disposed relative to a center of the radiator. In an electromagnetic wave radiation process, the second branches help improve matching effect between impedance of the radiator and impedance of the air, thereby helping improve a wave transmittance and wave transmission bandwidth.

A second aspect of embodiments of the present disclosure provides an FSS, including a plurality of FSS units described above, to form an FSS unit array. The FSS unit array has a plurality of metal shielding members, and the metal shielding members between the plurality of FSS units are independently disposed or at least partially shared.

Feed network components in the plurality of FSS units may be located in one metal shielding member of one of the FSS units, so that working personnel may install and maintain the plurality of feed network components in one metal shielding member, thereby helping reduce maintenance difficulty.

In a possible implementation, there are a plurality of shielding frames in the FSS units, and the plurality of shielding frames are periodically arranged in space in the FSS units.

A third aspect of embodiments of the present disclosure provides an antenna, including a first antenna array and the foregoing FSS. The first antenna array is located above the FSS, and the first antenna array is electrically connected to the feed network component in the FSS unit.

In a possible implementation, a second antenna array is further included. The second antenna array is located below the FSS, and the FSS is configured to transmit an electromagnetic wave radiated by the second antenna array, and reflect an electromagnetic wave radiated by the first antenna array.

In a possible implementation, a frequency band of the first antenna array is different from a frequency band of the second antenna array. Because the feed network component of the FSS unit in the present disclosure may not interfere with the first antenna array and the second antenna array, the FSS unit in the present disclosure is applicable to an application scenario in which the frequency band of the first antenna array is different from the frequency band of the second antenna array, to obtain signals of different frequency bands, thereby helping improve radiation effect of the antenna.

In a possible implementation, an operating frequency band of at least one of the first antenna array and the second antenna array is a multi-frequency band. Because the feed network component of the FSS unit in the present disclosure may not interfere with the first antenna array and the second antenna array, the FSS unit in the present disclosure is applicable to an application scenario in which the frequency band of the first antenna array or the second antenna array is a multi-frequency band, to obtain signals of the multi-frequency band, thereby helping improve radiation effect of the antenna.

A fourth aspect of embodiments of the present disclosure provides a communication device, including a radio frequency module and any one of the foregoing antennas. A transmission wire connects the feed network component in the FSS in the antenna to the radio frequency module.

In a possible implementation, signal transmission is performed between the radio frequency module and the second antenna array in the antenna by using the transmission wire.

A fifth aspect of embodiments of the present disclosure provides a communication system, including the foregoing communication device and a first radome. The first antenna array and the FSS in the communication device are located in the first radome.

A second radome is further included. The first radome and the second radome are stacked and connected along a first direction.

The second antenna array in the communication device is disposed in the second radome.

### BRIEF DESCRIPTION OF DRAWINGS

FIG. 1 is a diagram of an application scenario of an FSS unit according to an embodiment of the present disclosure;

FIG. 2 is an exploded diagram of a structure of an FSS unit according to an embodiment of the present disclosure;

FIG. 3 is an axonometric diagram of a structure of an FSS unit according to an embodiment of the present disclosure;

FIG. 4 is a schematic front view of a structure of an FSS unit according to an embodiment of the present disclosure;

FIG. 5 is a diagram of a partial structure of an FSS unit according to an embodiment of the present disclosure;

FIG. 6 is a diagram of a partial structure in which metal sheets are disposed on two surfaces of a substrate according to an embodiment of the present disclosure;

FIG. 7 is a diagram of a structure of a gap between an upper metal sheet and a lower metal sheet according to an embodiment of the present disclosure;

FIG. 8 is a diagram of a structure of a gap between an upper metal sheet and a lower metal sheet according to another embodiment of the present disclosure;

FIG. 9 is a diagram of a structure of a gap between an upper metal sheet and a lower metal sheet according to still another embodiment of the present disclosure;

FIG. 10 is a schematic top view of a structure of a radiation assembly according to an embodiment of the present disclosure;

FIG. 11 is a diagram of S11 and S21 simulation curves of an FSS unit according to an embodiment of the present disclosure;

FIG. 12 is an axonometric diagram of a structure of an FSS unit according to another embodiment of the present disclosure;

FIG. 13 is another axonometric diagram of a structure of an FSS unit according to another embodiment of the present disclosure;

FIG. 14 is an exploded diagram of a structure of an FSS unit according to another embodiment of the present disclosure;

FIG. 15 is a schematic front view of a structure of an FSS unit according to another embodiment of the present disclosure;

FIG. 16 is a diagram of S11 and S21 simulation curves of an FSS unit according to another embodiment of the present disclosure;

FIG. 17 is a schematic top view of a structure of a radiation assembly according to another embodiment of the present disclosure;

FIG. 18 is a diagram of a three-dimensional structure of an FSS according to another embodiment of the present disclosure;

FIG. 19 is a diagram of a three-dimensional structure of an antenna according to another embodiment of the present disclosure;

FIG. 20 is a diagram of a structure of a communication system according to the present disclosure; and

FIG. 21 is a diagram of a structure of a communication device according to the present disclosure.

Description of reference numerals: 200: antenna; 100: FSS; 100a: space; 110: FSS unit; 111: radiation assembly; 1111: radiator; 101: first branch; 102: second branch; 1111a: first slot; 1112: first metal layer; 1113: first dielectric plate; 1113a: first surface; 1113b: second surface; 1114: second dielectric plate; 1114a: third surface; 1114b: fourth surface; 1114c: second through hole; 112: receiving assembly; 1121: receiver; 1122: second metal layer; 1123: third dielectric plate; 1123a: fifth surface; 1123b: sixth surface; 1123c: third through hole; 1124: fourth dielectric plate; 1124a: seventh surface; 1124b: eighth surface; 113: transmission assembly; 1131: substrate; 1132: metal sheet; 1101: upper metal sheet; 1102: lower metal sheet; 1133: transmission wire; 114: feed network component; 115: shielding frame; 115a: opening; 116: shielding tube; 120: first antenna array; 121: antenna unit; 130: second antenna array; 131: array unit; 301: first radome; 302: second radome; 303: support rod; and 10: communication device; 300: radio frequency module.

### DESCRIPTION OF EMBODIMENTS

An FSS unit, an FSS, an antenna, and a communication device provided in embodiments of the present disclosure are applicable to various communication systems. For example, the communication systems may be a Long Term Evolution (LTE) system, a fifth generation (5G) communication system, a sixth generation (6G) communication system, a Global System for Mobile Communications (GSM), a code-division multiple access (CDMA) system, a wideband CDMA (WCDMA) system, a General Packet Radio Service (GPRS) system, an LTE time-division duplex (TDD) system, a Universal Mobile Telecommunication System (UMTS), and a Worldwide Interoperability For Microwave Access (WiMAX) communication system. Certainly, the FSS unit, the FSS, the antenna, and the communication device in embodiments of the present disclosure are also applicable to another communication system. This is not limited herein.

The communication device provided in the present disclosure may be a base station. The base station is applicable to a device that communicates with a terminal device, and includes a base transceiver station (BTS) in a GSM or a CDMA system, or may be a NodeB (NB) in a WCDMA system, or may be an evolved NodeB (evolved NodeB, eNB or eNodeB) in an LTE system, or may be a radio controller in a cloud radio access network (CRAN) scenario. Alternatively, the base station may include a relay station, an access point, an in-vehicle device, a wearable device, a base station in a future fifth generation (5G) network, a base station in a future evolved public land mobile network (PLMN), or the like. This is not limited in embodiments of the present disclosure.

The antenna may be provided with the FSS. The FSS is a two-dimensional periodic array structure with filtering performance. The FSS may include a plurality of FSS units (or FSS systems). It may be understood that the FSS may function as a spatial filter. The FSS may exhibit obvious passband or stopband filtering characteristics when interacting with electromagnetic waves. It may be understood that a passband is a frequency band range of electromagnetic waves that are allowed to pass through the FSS. A stopband is a frequency band range of electromagnetic waves that are not allowed to pass through the FSS.

The FSS may allow an electromagnetic wave of a specific frequency to pass through and prevent an electromagnetic wave of another frequency from passing through. Therefore, when a frequency of an electromagnetic wave is within the passband of the FSS, the electromagnetic wave may pass through the FSS and be radiated. When a frequency of an electromagnetic wave is outside the passband of the FSS, the electromagnetic wave may be reflected by the FSS.

When the FSS is applied in the antenna field, an antenna-filter-antenna architecture is usually used. The FSS may receive electromagnetic waves sent by one of the antennas, transmit an electromagnetic wave of a specific frequency in the received electromagnetic waves, and effectively filters out an electromagnetic wave of a frequency other than the frequency, to transmit a signal of the specific frequency to the outside. The FSS may reflect electromagnetic waves sent by the other antenna, to reduce mutual interference between the two antennas.

In a related technology, to reduce a possibility that internal space of a communication device is occupied when two antennas are disposed side by side in a horizontal plane, the two antennas are usually disposed in a stacked manner. The FSS is located between the two antennas. If one of the antennas is disposed above the FSS, a feed network component (for example, a phase shifter) of the antenna usually passes through an outer side of the FSS and feeds a signal into the antenna. However, the applicant finds that the feed network component is likely to cause interference to the other antenna disposed below the FSS, thereby affecting performance of the other antenna disposed below the FSS.

Therefore, to resolve the problem mentioned earlier, an embodiment of the present disclosure provides an FSS unit. The FSS unit includes a radiation assembly, a receiving assembly, and a transmission assembly that are stacked and spaced apart. The receiving assembly may be configured to receive a signal. The transmission assembly may transmit the signal received by the receiving assembly to a radiator, so that the radiator radiates the received signal to the outside, thereby avoiding mutual interference between a first antenna array and a second antenna array that are located on two sides of the FSS unit. In addition, a feed network component that is shielded from the transmission assembly is disposed between the radiation assembly and the receiving assembly. Therefore, the feed network component may be decoupled from the transmission assembly. When the feed network component feeds a signal into the first antenna array located above the FSS unit, interference is not likely to be generated between the signal transmitted by the feed network component and the signal transmitted by the transmission assembly, thereby helping improve radiation efficiency.

It may be understood that the feed network component may be a network structure configured to transmit the signal to the first antenna array. The feed network component may implement a power feeding function. The signal fed by the feed network component into the first antenna array may be a current or an electromagnetic wave. This is not limited in the present disclosure.

Therefore, the FSS unit provided in the present disclosure may not only reduce a possibility of mutual interference between the first antenna array and the second antenna array, but also reduce a possibility of interference between the signal transmitted by the feed network component and the signal transmitted by the transmission assembly, thereby preventing antenna radiation efficiency from being reduced, and preventing antenna performance from being affected.

The following describes in detail several structures of the FSS unit provided in this embodiment of the present disclosure. For ease of description, a first direction is an X direction, a second direction is a Y direction, and a third direction is a Z direction.

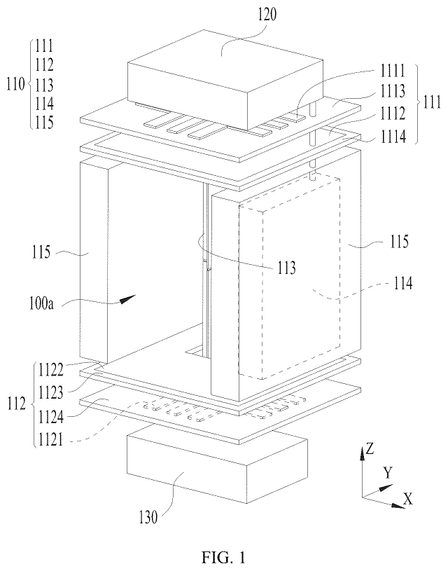

An embodiment of the present disclosure provides an FSS unit 110. As shown in FIG. 1, the FSS unit 110 includes a radiation assembly 111, a receiving assembly 112, and a transmission assembly 113 that are stacked and spaced apart. Along a third direction Z, the radiation assembly 111 and the receiving assembly 112 are spaced apart. A signal received by a receiver 1121 may be transmitted to the radiation assembly 111 by using the transmission assembly 113. For example, the signal received by the receiver 1121 may include electromagnetic waves of a plurality of frequencies. An electromagnetic wave of a specific frequency may pass through the radiation assembly 111 to implement signal transmission, to implement radiation. An electromagnetic wave of another frequency that does not generate radiation efficiency may be reflected by the radiation assembly 111, thereby implementing effect of being effectively filtered out.

The radiation assembly 111 may transmit an electromagnetic wave of a specific frequency in a signal fed by a first antenna array 120 disposed above the FSS unit 110, and reflect an electromagnetic wave of another frequency. The receiving assembly 112 may receive a signal fed by a second antenna array 130 located below the FSS unit 110, and the signal is transmitted to the radiation assembly 111 by using the transmission assembly 113. Similarly, the radiation assembly 111 may also transmit an electromagnetic wave of a specific frequency in the signal fed by the second antenna array 130, and reflect an electromagnetic wave of another frequency.

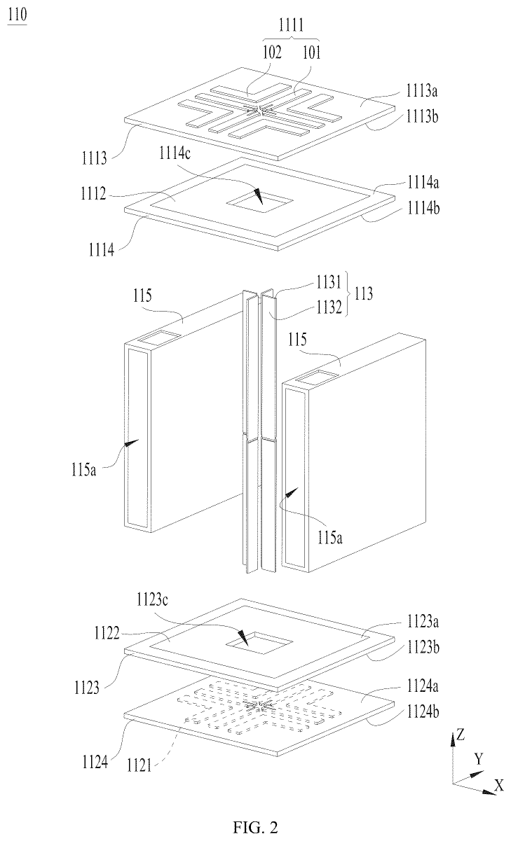

In addition, as shown in FIG. 2 to FIG. 4, a first metal layer 1112 may be configured to reflect an electromagnetic wave that passes through a radiator 1111. The receiving assembly 112 includes the receiver 1121 and a second metal layer 1122 that are stacked and spaced apart. The second metal layer 1122 may be configured to reflect an electromagnetic wave that passes through the receiver 1121. The first metal layer 1112 and the second metal layer 1122 are located between the radiator 1111 and the receiver 1121. An electromagnetic wave that is downward along the third direction Z passes through the radiator 1111 and the first metal layer 1112, and an electromagnetic wave of another frequency may be reflected. In addition, in electromagnetic waves that are upward along the third direction Z, electromagnetic waves received by the receiver 1121 may be transmitted to the radiation assembly 111 by using the transmission assembly 113, and may be reflected by the first metal layer 1112 and the radiator 1111 of the radiation assembly 111. An electromagnetic wave that passes through the receiver 1121 may be reflected by the second metal layer 1122.

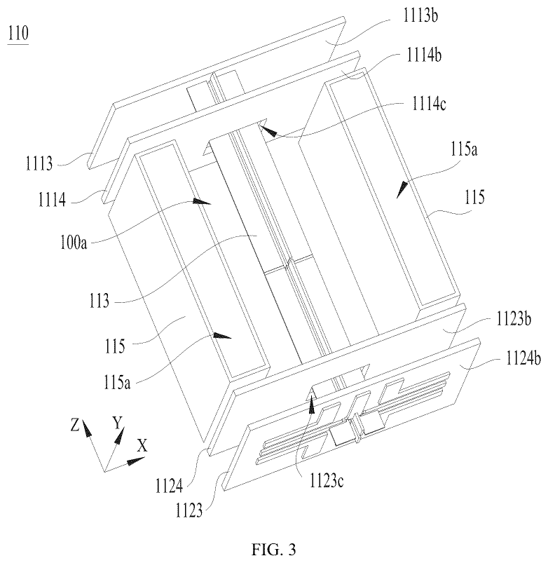

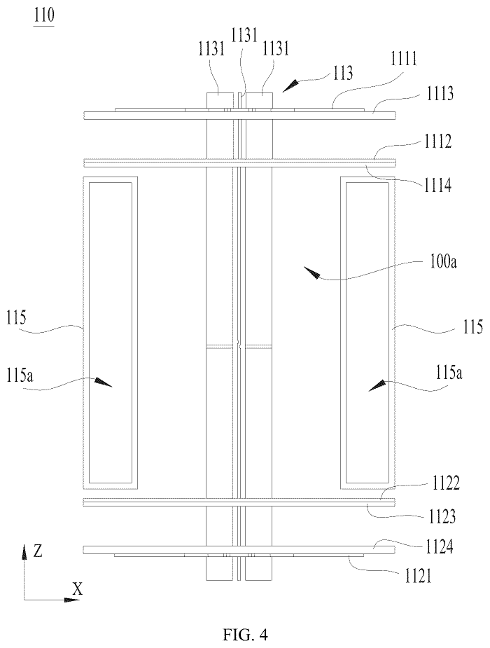

As shown in FIG. 3 and FIG. 4, one end of the transmission assembly 113 passes through the first metal layer 1112 to be electrically connected to the radiator 1111, and the other end of the transmission assembly 113 passes through the second metal layer 1122 to be electrically connected to the receiver 1121, so that the signal received by the receiver 1121 is transmitted to the radiator 1111 by using the transmission assembly 113, and then the radiator 1111 may radiate the received signal to the outside. Therefore, the first metal layer 1112 and the second metal layer 1122 may be jointly configured to reflect electromagnetic waves of other frequencies generated by the first antenna array 120 and the second antenna array 130 on two sides of the first metal layer 1112 and the second metal layer 1122, to improve isolation between the first antenna array 120 and the second antenna array 130, thereby improving radiation efficiency of an antenna 200.

In addition, there is space 100a between the radiation assembly 111 and the receiving assembly 112. The FSS unit 110 includes a feed network component 114 and at least one metal shielding member with a cavity. The metal shielding member and the feed network component 114 are located in the space 100a, and the metal shielding member may be configured to shield at least one of the transmission assembly 113 and the feed network component 114. The cavity of each metal shielding member may be configured to place the transmission assembly 113 or the feed network component 114.

The metal shielding member in this embodiment of the present disclosure may shield the transmission assembly 113 and the feed network component 114 from each other, so that when the feed network component 114 feeds a signal into the first antenna array 120 located above the FSS unit 110, interference is not likely to be generated between the signal transmitted by the feed network component 114 and the signal transmitted by the transmission assembly 113, thereby helping improve radiation efficiency.

In this embodiment, as shown in FIG. 4, along the third direction Z, the radiator 1111 and the first metal layer 1112 may be spaced apart. After an electromagnetic wave of another frequency passes through the radiator 1111, radiation space may be formed between the radiator 1111 and the first metal layer 1112. Then, the electromagnetic wave may be reflected by the first metal layer 1112. Reflection space may be formed for the electromagnetic wave in a spacing, to achieve better filtering effect. Similarly, the receiver 1121 and the second metal layer 1122 are spaced apart, so that radiation space may be formed between the receiver 1121 and the second metal layer 1122 for an electromagnetic wave that passes through the receiver 1121. Then, the electromagnetic wave may be reflected by the second metal layer 1122. In addition, reflection space may also be formed for the electromagnetic wave in a spacing.

In some examples, the radiator 1111 and the first metal layer 1112 may be spaced apart by a dielectric plate, or the radiator 1111 and the first metal layer 1112 may be spaced apart by a foam pad, or the radiator 1111 and the first metal layer 1112 may be spaced apart by a support.

Positions of the radiation assembly 111 and the receiving assembly 112 are not limited to the positions in FIG. 1. For example, the receiving assembly 112 may alternatively be located above the feed network component 114, and the radiation assembly 111 may be located below the feed network component 114. When feeding a signal into the feed network component 114, a feed may feed the signal through a side surface of the feed network component 114. For example, as shown in FIG. 1, the feed may feed the signal into the feed network component 114 along a second direction Y.

The radiator 1111 and the receiver 1121 may be conductors with specific shapes and sizes, for example, a linear shape or a sheet shape. The specific shapes are not limited in the present disclosure.

Along the third direction Z, the radiation assembly 111 further includes a first dielectric plate 1113 and a second dielectric plate 1114 that are stacked and spaced apart. Along a thickness direction of the first dielectric plate 1113, the first dielectric plate 1113 has a first surface 1113a and a second surface 1113b that are opposite to each other. The second dielectric plate 1114 has a third surface 1114a and a fourth surface 1114b that are opposite to each other. The second surface 1113b of the first dielectric plate 1113 is opposite to the third surface 1114a of the second dielectric plate 1114. The radiator 1111 is located on the first dielectric plate 1113. The radiator 1111 may be located on the first surface 1113a of the first dielectric plate 1113, or may be located on the second surface 1113b of the first dielectric plate 1113. This is not limited in the present disclosure.

In this embodiment, the first metal layer 1112 may be located on the third surface 1114a of the second dielectric plate 1114, or may be located on the fourth surface 1114b of the second dielectric plate 1114. The feed network component 114 is disposed between the second dielectric plate 1114 and the second metal layer 1122. The thickness direction of the first dielectric plate 1113 may be the same as the third direction Z.

It may be understood that, in an example in which the first metal layer 1112 is located on the third surface 1114a, the first metal layer 1112 may cover a part of the third surface 1114a, or may cover the entire third surface 1114a.

Along the third direction Z, the receiving assembly 112 further includes a third dielectric plate 1123 and a fourth dielectric plate 1124 that are stacked and spaced apart. Along a thickness direction of the third dielectric plate 1123, the third dielectric plate 1123 has a fifth surface 1123a and a sixth surface 1123b that are opposite to each other. The fourth dielectric plate 1124 has a seventh surface 1124a and an eighth surface 1124b that are opposite to each other. The sixth surface 1123b of the third dielectric plate 1123 is opposite to the seventh surface 1124a of the fourth dielectric plate 1124. The receiver 1121 is located on the fourth dielectric plate 1124, and the second metal layer 1122 is located on the third dielectric plate 1123. The feed network component 114 is disposed between the second dielectric plate 1114 and the third dielectric plate 1123. The thickness direction of the third dielectric plate 1123 may be the same as the third direction Z.

It may be understood that the receiver 1121 may be located on the seventh surface 1124a of the fourth dielectric plate 1124, or may be located on the eighth surface 1124b of the fourth dielectric plate 1124. The second metal layer 1122 may be located on the fifth surface 1123a of the third dielectric plate 1123, or may be located on the sixth surface 1123b. In an example in which the second metal layer 1122 is located on the fifth surface 1123a, the second metal layer 1122 may cover a part of the fifth surface 1123a, or may cover the entire fifth surface 1123a. This is not limited in the present disclosure.

Along the third direction Z, the first metal layer 1112 and the second metal layer 1122 are located between the radiator 1111 and the receiver 1121, and the feed network component 114 is located between the first metal layer 1112 and the second metal layer 1122. Therefore, the first metal layer 1112 and the second metal layer 1122 may reflect an external electromagnetic wave, to reduce interference caused by the external electromagnetic wave to the transmission assembly 113 located in a spacing between the first metal layer 1112 and the second metal layer 1122. In addition, because the transmission assembly 113 and the feed network component 114 are shielded from each other, when both the transmission assembly 113 and the feed network component 114 are located in a spacing between the radiation assembly 111 and the receiving assembly 112, mutual interference is not likely to be generated.

The feed network component 114 is electrically connected to the first antenna array 120 located above the FSS unit 110. It may be understood that an electrical connection may be a direct coupling connection, or may be a capacitive coupling connection. In some examples, the first dielectric plate 1113 and the second dielectric plate 1114 may be provided with avoidance holes. The feed network component 114 may be electrically connected to the first antenna array 120 through the avoidance holes.

It should be noted that the first metal layer 1112 and the second metal layer 1122 may be grounding planes, and are configured to ground components in a communication device. It may be understood that the grounding planes may be made of at least one of conductive materials such as copper, aluminum, and stainless steel. The first dielectric plate 1113, the second dielectric plate 1114, the third dielectric plate 1123, and the fourth dielectric plate 1124 may be printed circuit boards (PCBs). It may be understood that the first metal layer 1112 and the second dielectric plate 1114 may be an integrated structure, serving as a ground plate of the radiator 1111 in the FSS unit 110. The second metal layer 1122 and the third dielectric plate 1123 may be an integrated structure, serving as a ground plate of the receiver 1121 in the FSS unit 110.

As shown in FIG. 3 and FIG. 4, the third dielectric plate 1123 and the second dielectric plate 1114 are spaced apart, so that the space 100a may be formed. A part of the transmission assembly 113 and the feed network component 114 are located in the space 100a.

There is the space 100a between the fourth surface 1114b of the second dielectric plate 1114 and the fifth surface 1123a of the third dielectric plate 1123. The feed network component 114 may be disposed in the cavity of the metal shielding member.

It may be understood that the first metal layer 1112 on the second dielectric plate 1114 and the second metal layer 1122 on the third dielectric plate 1123 may be configured to reflect an external electromagnetic wave. Therefore, mutual interference is not generated between the part of the transmission assembly 113 and the feed network component 114 that are located in the space 100a, and the part of the transmission assembly 113 and the feed network component 114 are not interfered by radiation generated by the external first antenna array 120 and the external second antenna array 130, thereby helping improve isolation between the first antenna array 120 and the second antenna array 130.

In some examples, the metal shielding member may be a shielding frame 115. The shielding frame 115 may have one or more cavities. Two opposite side surfaces of the shielding frame 115 may be provided with openings 115a. The openings 115a may communicate with the space 100a.

At least one shielding frame 115 is disposed in the space 100a, and the shielding frame 115 may be located between the third dielectric plate 1123 and the second dielectric plate 1114. The feed network component 114 may be disposed in the cavity of the shielding frame 115.

The shielding frame 115 may shield the signal transmitted by the feed network component 114 and the signal transmitted by the transmission assembly 113 from each other, so that the two signals may not interfere with each other. In some examples, along the third direction Z, wire-threading holes may be provided at two ends of the shielding frame 115, and the wire-threading holes may correspond to the avoidance holes, so that the feed network component 114 may be electrically connected to the first antenna array 120 through the wire-threading holes and the avoidance holes.

In some examples, as shown in FIG. 2 to FIG. 4, when sizes of the wire-threading holes of the shielding frame 115 are relatively small, the shielding frame 115 may be further provided with the openings 115a. The openings 115a may be provided along the second direction Y, to facilitate disposing of the feed network component 114 in the shielding frame 115.

The metal shielding member is made of a metal material. The feed network component 114 may be disposed in the cavity of the shielding frame 115. Therefore, compared with a microstrip, the shielding frame 115 made of a metal material may reduce a link loss, and a processing technology is simple, thereby helping reduce processing costs.

In some examples, the first antenna array 120 may include a plurality of antenna units, or antenna systems, 121. Each antenna unit may correspond to one shielding frame 115. Therefore, a feed network component 114 disposed in each shielding frame 115 is electrically connected to an antenna unit 121 corresponding to the shielding frame 115. For example, two shielding frames 115 are disposed in the FSS unit 110 shown in FIG. 4. If one antenna unit 121 corresponds to one shielding frame 115, it may be understood that two antenna units 121 may be correspondingly disposed above the first dielectric plate 1113.

Along the third direction Z, a part of an orthographic projection of the shielding frame 115 may be located inside an orthographic projection of the second dielectric plate 1114, and a part of the orthographic projection of the shielding frame 115 may be located outside the orthographic projection of the second dielectric plate 1114. Alternatively, the orthographic projection of the shielding frame 115 may be entirely located inside the orthographic projection of the second dielectric plate 1114, and the orthographic projection of the shielding frame 115 may also be entirely located inside an orthographic projection of the third dielectric plate 1123, thereby reducing a possibility that arrangement of adjacent shielding frames 115 along a first direction X is affected because the orthographic projection of the shielding frame 115 exceeds the orthographic projections of the second dielectric plate 1114 and the third dielectric plate 1123 and occupies external space.

In some examples, the shielding frame 115 may be a frame with a thin-walled structure. A shielding cavity may be formed inside the shielding frame 115. A cross-sectional shape of the shielding frame 115 may be square, circular, or polygonal. This is not limited in the present disclosure.

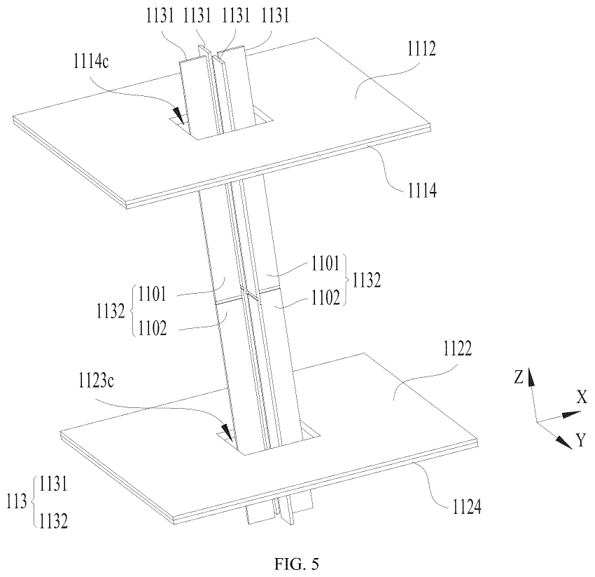

As shown in FIG. 3 and FIG. 5, the transmission assembly 113 includes at least one substrate 1131. One end of the substrate 1131 penetrates the second dielectric plate 1114 and the first dielectric plate 1113, and the other end of the substrate 1131 penetrates the third dielectric plate 1123 and the fourth dielectric plate 1124. Along a thickness direction (for example, the direction Y) of the substrate 1131, the substrate 1131 has two opposite surfaces, and a metal sheet 1132 may be disposed on at least one of the two opposite surfaces of the substrate 1131. Along the third direction Z, one end of the metal sheet 1132 is electrically connected to the receiver 1121, and the other end of the metal sheet 1132 is electrically connected to the radiator 1111. Therefore, electrical conduction between the radiator 1111 and the receiver 1121 may be implemented by using the metal sheet 1132.

In the two opposite surfaces of the substrate 1131 along the thickness direction, the metal sheet 1132 may be disposed on one surface of the substrate 1131, or the metal sheet 1132 may be disposed on each surface. When metal sheets 1132 are disposed on both opposite surfaces of the substrate 1131, a contact area of an electrical connection between the first dielectric plate 1113 and the second dielectric plate 1114 may be increased. In addition, because the two surfaces on which the metal sheets 1132 are disposed are opposite to each other and isolated, when a connection between a metal sheet 1132 on one surface and the first dielectric plate 1113 or the second dielectric plate 1114 fails, a metal sheet 1132 on the other surface may still maintain electrical conduction between the radiator 1111 and the receiver 1121, thereby helping improve stability of an electrical connection between the radiator 1111 and the receiver 1121.

The first dielectric plate 1113 may be provided with a first through hole. For example, the first through hole may be located in a central region of the radiator 1111. The substrate 1131 and the metal sheet 1132 may be an integrated structure. A shape of the first through hole may match a cross-sectional shape of the integrated structure including the substrate 1131 and the metal sheet 1132. The second dielectric plate 1114 may be provided with a second through hole 1114c. The second through hole 1114c corresponds to the first through hole. The third dielectric plate 1123 may be provided with a third through hole 1123c. One end of the integrated structure including the substrate 1131 and the metal sheet 1132 may penetrate the second through hole 1114c, to be electrically connected to the radiator 1111; and the other end of the integrated structure including the substrate 1131 and the metal sheet 1132 may penetrate the third through hole 1123c, to be electrically connected to the receiver. Cross-sectional shapes of the second through hole 1114c and the third through hole 1123c may be square, circular, or polygonal. Specific shapes are not limited in the present disclosure. The fourth dielectric plate 1124 may be provided with a fourth through hole. For example, the fourth through hole may be located in a central region of the receiver 1121. The fourth through hole corresponds to the third through hole 1123c. A cross-sectional shape of the fourth through hole may be the same as a cross-sectional shape of the first through hole.

In addition, there may be a plurality of substrates 1131. For example, as shown in FIG. 5, there may be four substrates 1131. The four substrates 1131 may be evenly distributed around a center line of the first through hole. The four substrates 1131 include two groups of substrates 1131 disposed opposite to each other, and an included angle between every two adjacent substrates 1131 is a right angle. The four substrates 1131 may be connected to each other. Metal sheets 1132 may be disposed on two surfaces of each substrate 1131, and the metal sheets 1132 may not be connected to each other.

It should be noted that, due to impact of a manufacturing technology level and an installation technology level, the central regions indicated in this embodiment of the present disclosure may have errors in a specific range, and a person skilled in the art may consider that the errors are negligible. Therefore, the central regions do not indicate or imply that the two ends of the substrate 1131 need to respectively penetrate the exact central regions of the radiator 1111 and the receiver 1121. The central region is not an absolute mathematically strict definition.

As shown in FIG. 4 and FIG. 6 to FIG. 9, along the third direction Z, the metal sheet 1132 includes an upper metal sheet 1101 and a lower metal sheet 1102. There is a gap between the upper metal sheet 1101 and the lower metal sheet 1102. Coupling transmission is implemented between the upper metal sheet 1101 and the lower metal sheet 1102.

In this embodiment, the upper metal sheet 1101 and the lower metal sheet 1102 are spaced apart, so that an equivalent capacitor may be formed, to implement signal transmission. Impedance matching between the antenna and the transmission assembly 113 may be implemented by adding the capacitor to a transmission path between the receiver 1121 and the radiator 1111. When the antenna matches the transmission assembly 113, a reflected wave is not likely to occur on the transmission assembly 113, so that a loss on the transmission assembly 113 is reduced, thereby helping improve radiation performance.

When the metal sheets 1132 on both surfaces of the substrate 1131 are provided with gaps, along a length direction of the substrate 1131, a gap t1 of a metal sheet 1132 on one surface of the substrate 1131 and a gap t2 of a metal sheet 1132 on the other surface of the substrate 1131 are staggered. Being staggered may mean that, along the third direction Z, a gap t1 between an upper metal sheet 1101 and a lower metal sheet 1102 on one surface does not correspond to a gap t2 between an upper metal sheet 1101 and a lower metal sheet 1102 on the other surface. The gap t1 of the metal sheet 1132 on one surface of the substrate 1131 and the gap t2 of the metal sheet 1132 on the other surface of the substrate 1131 are spaced apart.

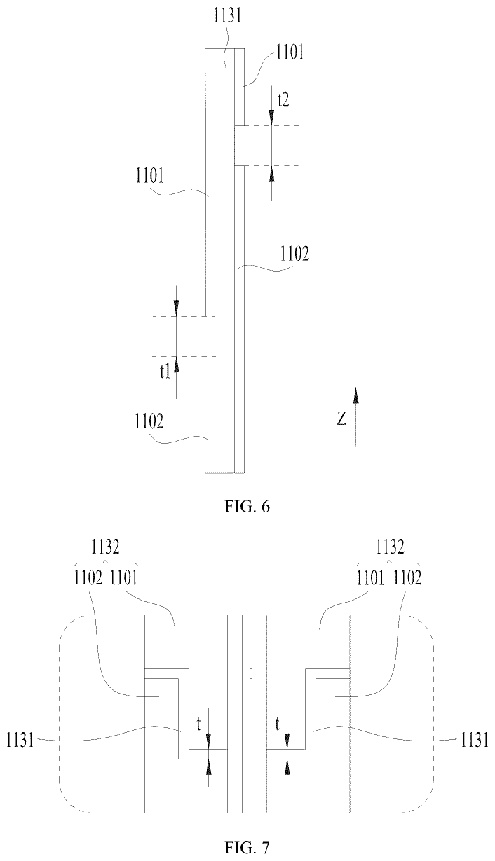

FIG. 6 is a diagram of a structure in which metal sheets 1132 are disposed on two surfaces of a substrate 1131 in the middle of the transmission assembly 113 shown in FIG. 4. With reference to a direction shown in FIG. 6, after a gap t1 and a gap t2 on two sides of the substrate 1131 are staggered, in a metal sheet 1132 on a left side, coupling transmission may be implemented between a lower metal sheet 1102 and an upper metal sheet 1101 on the same side by using the gap t1; and in a region in which the gap t1 of the metal sheet 1132 on one surface of the substrate 1131 and the gap t2 of the metal sheet 1132 on the other surface of the substrate 1131 are spaced apart, coupling transmission may be implemented between the upper metal sheet 1101 on the left side and a lower metal sheet 1102 on a right side. Coupling transmission may be implemented between the lower metal sheet 1102 on the right side and an upper metal sheet 1101 on the same side by using the gap t2, to complete signal transmission. Therefore, the gap t1 and the gap t2 are staggered, so that a contact area of coupling transmission may be effectively increased, to improve signal transmission effect.

As shown in FIG. 7 to FIG. 9, when a metal sheet 1132 is disposed on one surface of a substrate 1131, a gap t between an upper metal sheet 1101 and a lower metal sheet 1102 may include at least one horizontal gap and at least one vertical gap, and the horizontal gap communicates with the vertical gap.

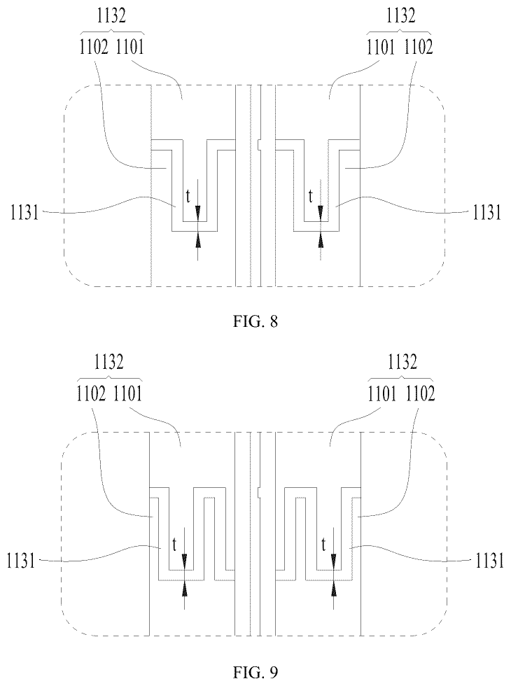

In some examples, the gap t between the upper metal sheet 1101 and the lower metal sheet 1102 may include two horizontal gaps and one vertical gap, to form a gap structure shown in FIG. 7 on the metal sheet 1132. Alternatively, the gap t between the upper metal sheet 1101 and the lower metal sheet 1102 may include three horizontal gaps and two vertical gaps, to form a gap structure shown in FIG. 8. Alternatively, the gap t between the upper metal sheet 1101 and the lower metal sheet 1102 may include four horizontal gaps and three vertical gaps, to form a gap structure shown in FIG. 9. It should be noted that surfaces that are of the upper metal sheet 1101 and the lower metal sheet 1102 and that are opposite to each other are not limited to flat surfaces. For example, the surfaces that are of the upper metal sheet 1101 and the lower metal sheet 1102 and that are opposite to each other may alternatively be curved surfaces. This is not limited in the present disclosure.

The gap t of the foregoing structure may increase a contact area of coupling transmission between the upper metal sheet 1101 and the lower metal sheet 1102, thereby helping improve signal transmission effect.

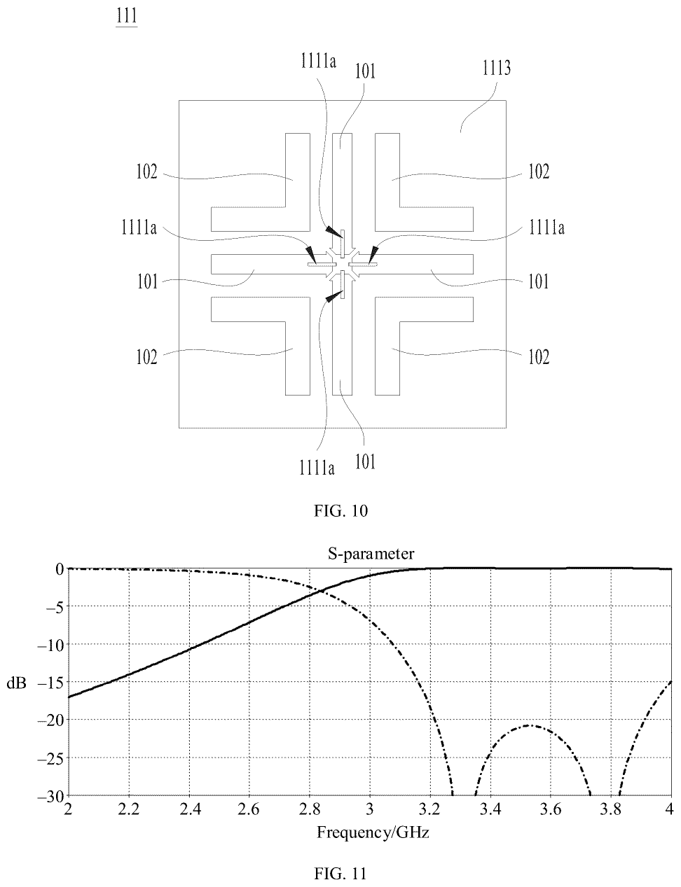

As shown in FIG. 10, one end that is of the radiator 1111 and that faces the first dielectric plate 1113 has at least one first slot 1111a that is in a one-to-one correspondence with the at least one substrate 1131. Along the third direction Z, one end of each substrate 1131 is inserted into the first slot 1111a corresponding to the substrate 1131, and one end of the metal sheet 1132 disposed on at least one surface of the substrate 1131 is in electrical contact with the radiator 1111. The first slot 1111a has two surfaces that are opposite to each other. Therefore, when metal sheets 1132 are disposed on the two surfaces of the substrate 1131, the metal sheets 1132 disposed on the two surfaces of the substrate 1131 may be respectively in electrical contact with the two surfaces of the first slot 1111a.

One end that is of the receiver 1121 and that faces the fourth dielectric plate 1124 has at least one second slot that is in a one-to-one correspondence with the at least one substrate 1131. Along the third direction Z, the other end of each substrate 1131 is inserted into the second slot corresponding to the substrate 1131, and the other end of the metal sheet 1132 disposed on at least one surface of the substrate 1131 is in electrical contact with the receiver 1121. The second slot has two surfaces that are opposite to each other. Therefore, when metal sheets 1132 are disposed on the two surfaces of the substrate 1131, the metal sheets 1132 disposed on the two surfaces of the substrate 1131 may be respectively in electrical contact with the two surfaces of the second slot.

It may be understood that a quantity of first slots 1111a on the radiator 1111 may correspond to a quantity of substrates 1131. A cross-sectional shape of the first slot 1111a may match a shape of the substrate 1131. A quantity of second slots on receiver 1121 may correspond to the quantity of substrates 1131. A cross-sectional shape of the second slot may match the shape of the substrate 1131.

When at least one shielding frame 115 is disposed in the space 100a, as shown in FIG. 11, FIG. 11 shows S11 and S21 simulation curves of the antenna 200 in this embodiment. It may be learned from FIG. 11 that the FSS unit 110 may transmit a high-frequency electromagnetic wave (for example, 3.5 gigahertz (GHz)) emitted by the second antenna array 130 located below the FSS unit 110, and may reflect a low-frequency electromagnetic wave (for example, 2.5 GHZ) of the first antenna array 120 located above the FSS unit 110. Therefore, the FSS unit 110 in the present disclosure may select a frequency of a to-be-transmitted electromagnetic wave, to improve radiation effect.

It may be understood that S21 represents an insertion loss, that is, a quantity of signals that may be transmitted to a destination end. This indicator may reflect an antenna gain. S11 represents a return loss, that is, a quantity of signals reflected to a source end. This indicator may reflect matching performance of the antenna.

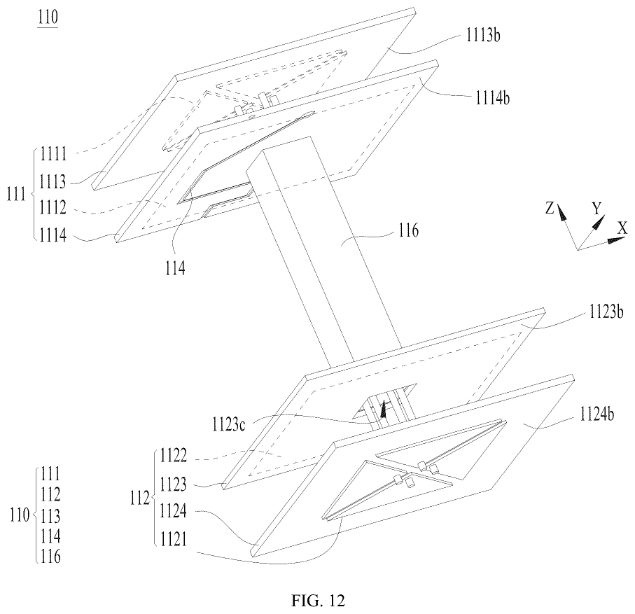

As shown in FIG. 12, the feed network component 114 may be disposed on the fourth surface 1114b of the second dielectric plate 1114. The feed network component 114 and the first metal layer 1112 are respectively located on two sides of the second dielectric plate 1114. That is, the first metal layer 1112 is located on the third surface 1114a of the second dielectric plate 1114. The first metal layer 1112 and the second metal layer 1122 are respectively disposed on the second dielectric plate 1114 and the third dielectric plate 1123. Therefore, the first metal layer 1112 and the second metal layer 1122 may reflect an external electromagnetic wave, to reduce interference caused by the external electromagnetic wave to an electronic element in the space 100a. Therefore, the feed network component 114 in the space 100a is not likely to cause interference to the second antenna array 130 located below the FSS unit 110.

In some examples, along the third direction Z, an orthographic projection of the feed network component 114 may be located inside an orthographic projection of the second metal layer 1122 on the third dielectric plate 1123, so that the first metal layer 1112 and the second metal layer 1122 may shield impact of an external electromagnetic wave for the feed network component 114.

As shown in FIG. 12 to FIG. 15, the metal shielding member may be a shielding tube. A shape of the shielding tube is not limited. For example, a cross-sectional shape of the shielding tube may be circular, rectangular, or another shape. The shielding tube 116 may be located in the space 100a. Along the third direction Z, one end of the shielding tube 116 is connected to the second dielectric plate 1114. For example, one end of the shielding tube 116 may be connected to the fourth surface 1114b of the second dielectric plate 1114 and electrically connected to the first metal layer 1112, and the other end of the shielding tube 116 is connected to the third dielectric plate 1123 and electrically connected to the second metal layer 1122. The transmission assembly 113 penetrates the shielding tube 116.

The shielding tube 116 may peripherally surround a part of the transmission assembly 113 between the second dielectric plate 1114 and the third dielectric plate 1123, to shield the signal transmitted by the transmission assembly 113, thereby confining the signal in the shielding tube 116. Therefore, the shielding tube 116 may shield the signal transmitted by the feed network component 114 and the signal transmitted by the transmission assembly 113 from each other, so that the two signals may not interfere with each other. In some examples, the feed network component 114 may pass through the avoidance holes on the second dielectric plate 1114 and the first dielectric plate 1113 to be electrically connected to the first antenna array 120.

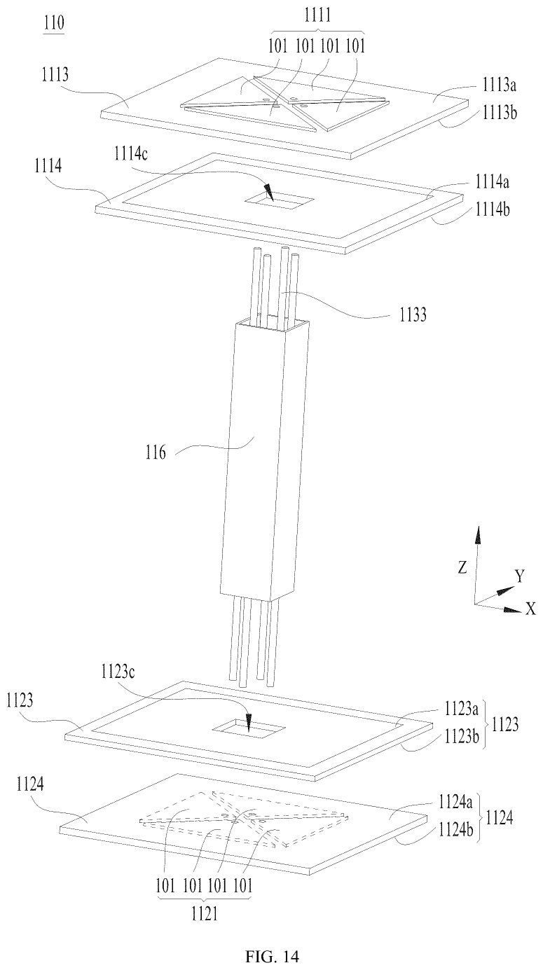

In some examples, there may be one shielding tube 116. As shown in FIG. 14, one end of the shielding tube 116 may correspond to the second through hole 1114c on the second dielectric plate 1114, and the other end of the shielding tube 116 may correspond to the third through hole 1123c on the third dielectric plate 1123. The shielding tube 116 may block the second through hole 1114c and the third through hole 1123c.

It may be understood that the shielding tube 116 may be a hollow metal tube structure with a thin-walled structure. A cross-sectional shape of the shielding tube 116 may be square, circular, or polygonal. A specific shape is not limited in the present disclosure. It may be understood that the shielding tube 116 may be made of a metal material.

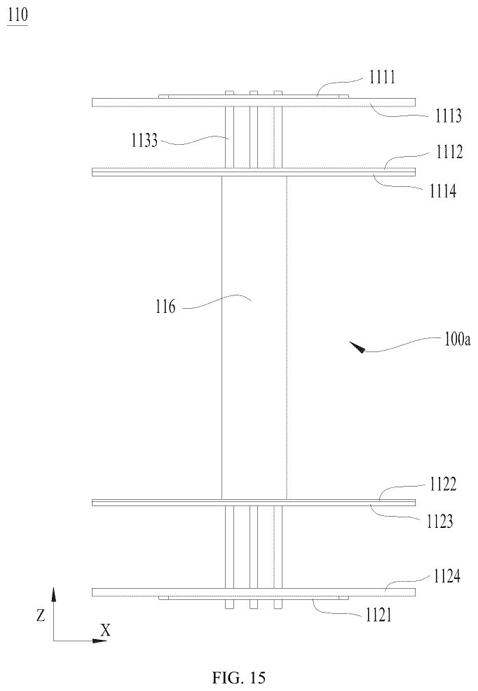

As shown in FIG. 14 and FIG. 15, the transmission assembly 113 includes at least one transmission wire 1133. One end of the transmission wire 1133 passes through the shielding tube 116, the second dielectric plate 1114, and the first dielectric plate 1113 to be electrically connected to the radiator 1111, and the other end of the transmission wire 1133 passes through the third dielectric plate 1123 and the fourth dielectric plate 1124 to be electrically connected to the receiver 1121.

The transmission wire 1133 is configured to transmit a signal received by the receiving assembly 112 to the radiation assembly 111. One end of the transmission wire 1133 may penetrate the second through hole 1114c on the second dielectric plate 1114, and be electrically connected to the radiator 1111. The other end of the transmission wire 1133 may penetrate the third through hole 1123c on the third dielectric plate 1123, and be electrically connected to the receiver 1121.

It should be noted that a structure configured to transmit a signal may be but is not limited to the transmission wire 1133, or may be a coaxial line, or may be the metal sheet 1132 in the foregoing embodiment.

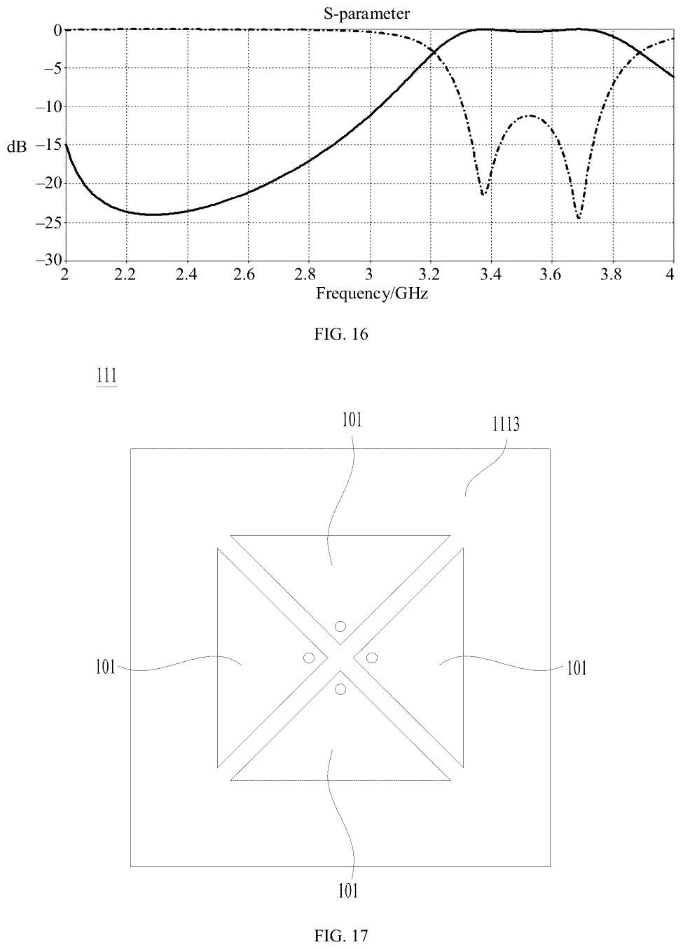

When the shielding tube 116 is disposed in the space 100a, as shown in FIG. 16, FIG. 16 shows S11 and S21 simulation curves of the antenna 200 in this embodiment. It may be learned from FIG. 16 that the FSS unit 110 may transmit a high-frequency electromagnetic wave (for example, 3.5 GHz) emitted by the second antenna array 130 located below the FSS unit 110, and may reflect a low-frequency electromagnetic wave (for example, 2.5 GHz) of the first antenna array 120 located above the FSS unit 110.

In addition, as shown in FIG. 2, the radiator 1111 and the receiver 1121 each include a plurality of first branches 101. The first branches 101 are electrically connected to the transmission assembly 113. In an example in which the transmission assembly 113 includes the substrate 1131, the radiator 1111 is provided with the first slot 1111a, and the receiver 1121 is provided with the second slot. Along the third direction Z, one end of the substrate 1131 may be inserted into the first slot 1111a, and the other end may be inserted into the second slot. In addition, metal sheets 1132 are disposed on two sides of the substrate 1131, and the metal sheets 1132 may implement electrical conduction between the transmission assembly 113 and the first branches 101. Therefore, the metal sheets 1132 may be separately connected to the first branches 101 of the radiator 1111 and the receiver 1121, to feed a signal.

In some examples, the radiator 1111 may be a dipole radiator. For example, with reference to a direction shown in FIG. 10, two first branches 101 that correspond to each other on the left and right may form a dipole radiator. Two first branches 101 that correspond to each other at the top and bottom may form a dipole radiator.

A structure of the radiator 1111 may include but is not limited to an axisymmetric structure or a rotationally symmetric structure. Certainly, in some examples, the structure of the radiator 1111 is alternatively an asymmetric structure; or in some examples, a part of the structure of the radiator 1111 is symmetric, and a part of the structure is asymmetric. Similarly, a structure of the receiver 1121 may include but is not limited to an axisymmetric structure or a rotationally symmetric structure. Certainly, in some examples, the structure of the receiver 1121 is alternatively an asymmetric structure; or in some examples, a part of the structure of the receiver 1121 is symmetric, and a part of the structure is asymmetric.

As shown in FIG. 2 and FIG. 10, the quantity of substrates 1131 may correspond to a quantity of first branches 101. For example, when there are four substrates 1131, the radiator 1111 may include four first branches 101. The four first branches 101 may be evenly distributed around the central region of the radiator 1111. Two opposite first branches 101 are collinear, and an included angle between two adjacent first branches 101 is a right angle. The four first branches 101 may be close to each other at one end. Each substrate 1131 may be correspondingly inserted into the first slot 1111a on the first branch 101, so that the metal sheet 1132 on the substrate 1131 may be attached to the first slot 1111a.

Ends that are of the four first branches 101 and that are close to each other are not connected to each other. Therefore, one first branch 101 of the receiver 1121 may feed a signal into a corresponding first branch 101 of the radiator 1111 by using a metal sheet 1132 on one substrate 1131, and another first branch 101 of the receiver 1121 may feed a signal into a corresponding first branch 101 of the radiator 1111 by using a metal sheet 1132 on another substrate 1131. First branches 101 of the radiator 1111 are independent of each other. As shown in FIG. 10, a shape of the first branch 101 may be a long strip. In some examples, one end of each of the four long-strip-shaped first branches 101 may point to the central region of the radiator 1111.

Alternatively, the shape of the first branch 101 may be a triangle. For example, as shown in FIG. 17, the shape of the first branch 101 is a triangle, and there may be four first branches 101. In this case, at least one transmission wire 1133 is electrically connected to one of the first branches 101. The four triangular first branches 101 may be close to each other at one corner. The corners close to each other may be provided with connection through holes, and the transmission wires 1133 may be electrically connected to the first branches 101 through the connection through holes. For example, a quantity of transmission wires 1133 of the transmission assembly 113 may correspond to the quantity of first branches 101. It should be noted that the shape of the first branch 101 is not limited to the foregoing long-strip-shaped, triangular, or serpentine structure, and the shape of the first branch 101 may alternatively be a rhombus or a hexagon. An arrangement manner of the plurality of first branches 101 may alternatively be a tightly coupled array arrangement, a sparse array arrangement, or the like. This is not limited in the present disclosure.

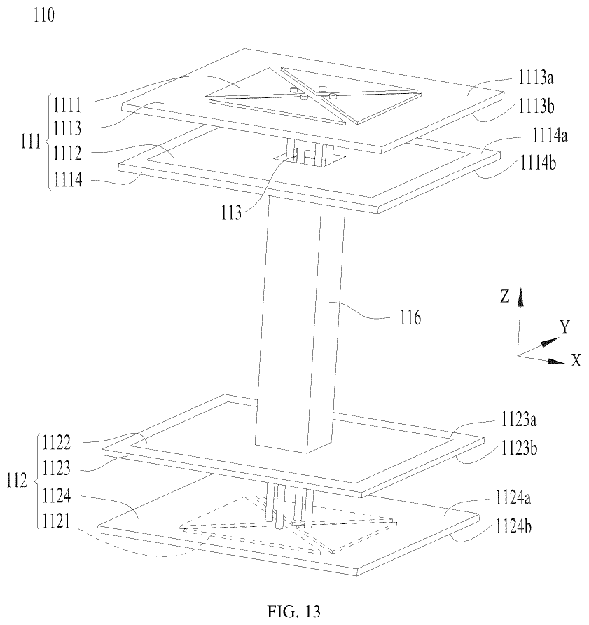

As shown in FIG. 12 and FIG. 13, an orthographic projection of the radiator 1111 onto the receiver 1121 coincides with the receiver 1121. For example, along the third direction Z, an outer contour of the radiator 1111 may coincide with an outer contour of the receiver 1121. In addition, the first branches 101 of the radiator 1111 correspond to the first branches 101 of the receiver 1121. In other words, along the third direction Z, orthographic projections of the first branches 101 of the radiator 1111 may coincide with orthographic projections of the first branches 101 of the receiver 1121, so that signals received by the FSS unit 110 may correspond to signals radiated by the FSS unit 110, thereby helping improve performance of the antenna 200.

It should be noted that, along the third direction Z, the orthographic projection of the radiator 1111 may alternatively not completely coincide with an orthographic projection of the receiver 1121.

As shown in FIG. 10, the radiator 1111 and the receiver 1121 each further include a plurality of second branches 102 that are respectively coupled to the plurality of first branches 101. One second branch 102 may be disposed in space formed by two adjacent first branches 101. The second branches 102 and the first branches 101 may be spaced apart.

In an electromagnetic wave radiation process, the second branches 102 help improve matching effect between impedance of the radiator 1111 and impedance of the air, thereby helping improve a wave transmittance and wave transmission bandwidth. For a high-frequency electromagnetic wave (for example, 3.5 GHz), the plurality of second branches 102 may be symmetrically disposed relative to a center of the radiator 1111.

In some examples, a spacing parameter between the second branch 102 and the first branch 101 may be obtained through an experiment or simulation.

For example, a shape of the second branch 102 may be an “L” shape. Two sides of the “L”-shaped second branch 102 may be respectively parallel to two adjacent first branches 101, and the two sides of the second branch 102 may be respectively coupled to the two adjacent first branches 101, to perform signal transmission. The second branch 102 may be a patch branch.

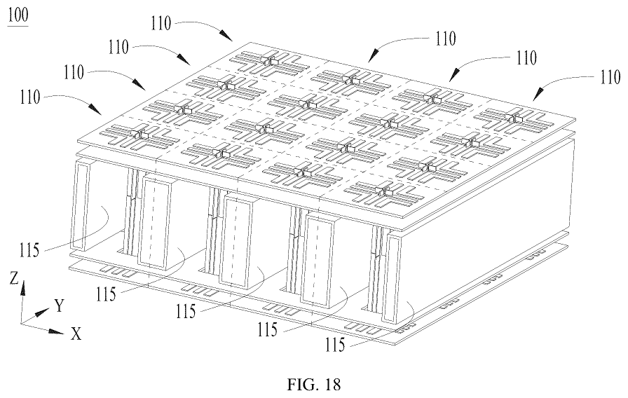

As shown in FIG. 18, another aspect of embodiments of the present disclosure further provides an FSS 100. The FSS 100 includes a plurality of FSS units 110 according to any one of the foregoing embodiments, to form an FSS unit array, or FSS system array. The FSS unit array may have a plurality of shielding frames 115. The shielding frames 115 between the plurality of FSS units 110 may be independently disposed or at least partially shared. For example, along a first direction X, two adjacent FSS units 110 may share a shielding frame 115 located between the two FSS units 110.

The plurality of shielding frames 115 may be periodically arranged in the space 100a. The plurality of FSS units 110 may be periodically arranged along at least one of the first direction X and a second direction Y. Correspondingly, the plurality of radiation assemblies 111 and the plurality of receiving assemblies 112 may also be periodically arranged along at least one of the first direction X and the second direction Y. In addition, two adjacent radiation assemblies 111 are connected, and two adjacent receiving assemblies 112 are connected. The plurality of shielding frames 115 are spaced apart along the first direction X.

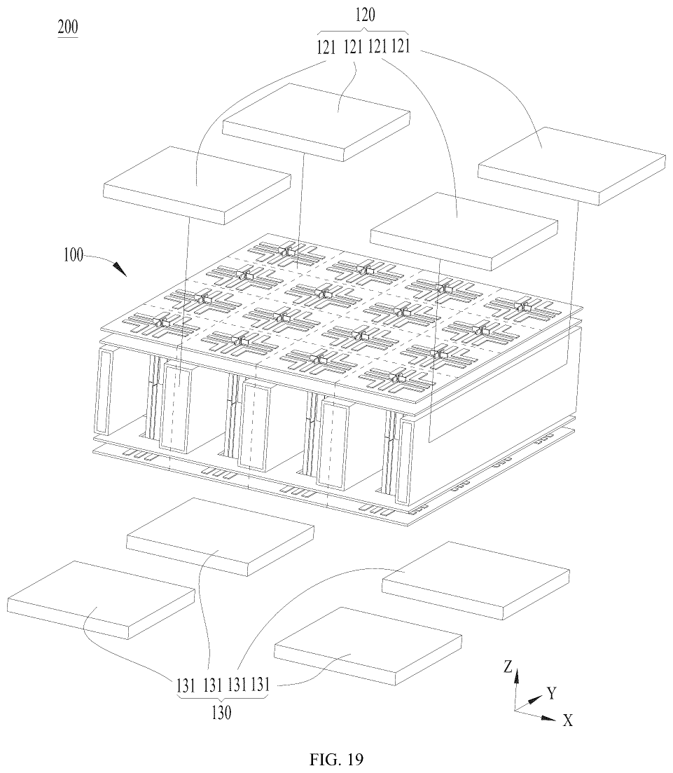

As shown in FIG. 19, another aspect of embodiments of the present disclosure further provides an antenna 200. The antenna 200 includes the FSS 100 and a first antenna array 120; or the antenna may further include a second antenna array 130. The first antenna array 120 is located above the FSS 100, and the first antenna array 120 is electrically connected to the feed network component 114. When the second antenna array 130 is included, the second antenna array 130 is located below the FSS 100. The FSS 100 is configured to transmit an electromagnetic wave radiated by the second antenna array 130, and reflect an electromagnetic wave radiated by the first antenna array 120. It should be noted that, in this embodiment of the present disclosure, an operating frequency band of the first antenna array 120 may be different from an operating frequency band of the second antenna array 130.

In addition, an operating frequency band of at least one of the first antenna array 120 and the second antenna array 130 is a multi-frequency band. For example, the first antenna array may include a plurality of antenna units 121. Operating frequency bands of the plurality of antenna units 121 may be different from each other. The second antenna array 130 may include a plurality of array units 131. Operating frequency bands of the plurality of array units 131 may be different from each other.

It may be understood that, when there is a plurality of shielding frames 115, a quantity of antenna units 121 may not need to match a quantity of shielding frames 115, and it is not necessary to dispose the feed network component 114 in each shielding frame 115. A quantity of array units 131 located below the fourth dielectric plate 1124 is irrelevant to the quantity of shielding frames 115. The plurality of array units 131 may be randomly arranged.

In the antenna 200 in this embodiment, the FSS 100 may transmit electromagnetic waves of a specific frequency in the first antenna array 120 and the second antenna array 130, and may reflect an electromagnetic wave of another frequency by using the radiation assembly 111, so that the first antenna array 120 and the second antenna array 130 are not likely to interfere with each other, thereby helping improve isolation between the first antenna array 120 and the second antenna array 130. In addition, the feed network component 114 and the transmission assembly 113 are shielded from each other, so that when the feed network component 114 feeds a signal into the first antenna array 120 located above the FSS 100, interference is not likely to be generated between the signal transmitted by the feed network component 114 and a signal transmitted by the transmission assembly 113, thereby helping improve radiation efficiency of the antenna 200.

Refer to FIG. 21. Another aspect of embodiments of the present disclosure further provides a communication device 10. The communication device 10 includes a radio frequency module 300 and the antenna 200 according to any one of the foregoing embodiments. The radio frequency module 300 may be a radio remote unit (RRU) or another device with a similar function. The antenna 200 and the RRU may be implemented as one integrated device, or may be implemented as two independent devices connected by using a connection structure such as a cable.

The radio frequency module 300 may perform signal transmission with the feed network component 114 and the second antenna array 130. The radio frequency module 300 may be configured to convert baseband energy into a high-frequency current, and emit energy in a form of an electromagnetic wave by using the radiation assembly 111 of the antenna 200. In addition, the radio frequency module 300 may further convert a high-frequency current (the radiation assembly 111 may convert received electromagnetic wave energy into high-frequency current energy) from the radiation assembly 111 of the antenna 200 into baseband energy.

The communication device may be a base station. The base station may be installed at a position such as the top of a tower or the top of a building. The base station may include a transmit end and a receive end. Therefore, the base station may transmit energy to a terminal, and may also receive energy sent by the terminal. Energy transmission may be performed between the base station and the terminal.

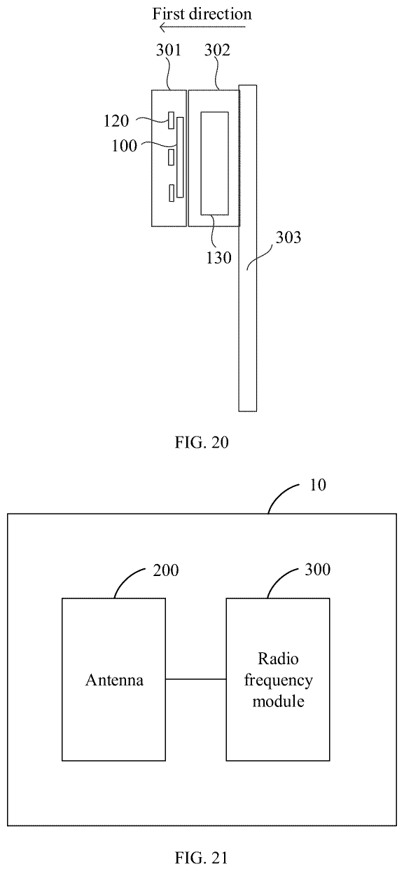

Another aspect of embodiments of the present disclosure further provides a communication system. As shown in FIG. 20, the communication system includes the foregoing communication device and a first radome 301. The first antenna array 120 and the FSS 100 in the communication device are located in the first radome 301.

In a possible implementation, the communication system further includes a second radome 302. The first radome 301 and the second radome 302 are stacked and connected along a first direction, and the second antenna array 130 in the communication device is disposed in the second radome 302.

In a possible implementation, the communication system further includes a support rod 303, and the second radome 302 may be connected to the support rod 303, to support the first radome 301 and the second radome 302 on the support rod 303.

In descriptions of embodiments of the present disclosure, it should be noted that, unless otherwise clearly specified and limited, the term “installation”, “interconnection”, or “connection” should be understood in a broad sense, for example, may be fastening, may be an indirect connection through an intermediate medium, or may be an internal connection between two elements or an interaction relationship between two elements. A person of ordinary skill in the art may understand specific meanings of the foregoing terms in embodiments of the present disclosure based on specific cases.

In embodiments of the present disclosure, it is implied that an apparatus or element in question needs to have a particular orientation, or needs to be constructed and operated in a particular orientation, and therefore cannot be construed as a limitation on embodiments of the present disclosure. In the description of embodiments of the present disclosure, unless otherwise exactly and specifically ruled, “a plurality of” means two or more.

In the specification, claims, and accompanying drawings of embodiments of the present disclosure, the terms “first”, “second”, “third”, “fourth”, and so on (if existent) are intended to distinguish between similar objects but do not necessarily indicate a specific order or sequence. It should be understood that the data termed in such a way is interchangeable in proper circumstances so that embodiments of the present disclosure described herein can be implemented in other orders than the order illustrated or described herein. In addition, the terms “include” and “have” and any other variants are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

The term “a plurality of” in this specification means two or more. The term “and/or” in this specification describes only an association relationship between associated objects and indicates that three relationships may exist. For example, A and/or B may indicate the following three cases: Only A exists, both A and B exist, and only B exists. In addition, a character “/” in this specification usually indicates an “or” relationship between associated objects, and a character “/” in a formula usually indicates a “divisible”relationship between associated objects.

It may be understood that various numbers in embodiments of the present disclosure are merely used for differentiation for ease of description, and are not used to limit the scope of embodiments of the present disclosure.

It may be understood that sequence numbers of the foregoing processes do not mean execution sequences in embodiments of the present disclosure. The execution sequences of the processes should be determined based on functions and internal logic of the processes, and should not be construed as any limitation on the implementation processes of embodiments of the present disclosure.

What is claimed is:

1. A frequency-selective surface (FSS) system comprising:
a radiation assembly comprising:
a radiator configured to radiate energy to outside of the FSS system; and
a first metal layer, wherein the radiator and the first metal layer are stacked and spaced apart;
a receiving assembly spaced apart from the radiation assembly and comprising:
a receiver configured to receive the energy from a terminal; and
a second metal layer, wherein the receiver and the second metal layer are stacked and spaced apart, and wherein the first metal layer and the second metal layer are located between the radiator and the receiver;
a transmission assembly comprising:
a first transmission assembly end passing through the first metal layer to be electrically connected to the radiator; and
a second transmission assembly end passing through the second metal layer to be electrically connected to the receiver, wherein the transmission assembly is configured to transmit the energy from the receiver to the radiator, and wherein the radiation assembly, the receiving assembly, and the transmission assembly are stacked and spaced apart;
feed network component; and
at least one metal shielding member comprising a cavity, wherein the at least one metal shielding member and the feed network component are located in the space, wherein the at least one metal shielding member is configured to shield at least one of the transmission assembly or the feed network component, and wherein the transmission assembly or the feed network component is housed within the cavity.

2. The FSS system of claim 1, wherein the radiation assembly further comprises:
a first dielectric plate comprising:
a first dielectric plate surface; and
a second dielectric plate surface opposite the first dielectric plate surface; and
a second dielectric plate, wherein the first dielectric plate and the second dielectric plate are stacked and spaced apart, and wherein the second dielectric plate comprises:
a third dielectric plate surface; and
a fourth dielectric plate surface opposite the third dielectric plate surface, wherein the second dielectric plate surface is opposite to the third dielectric plate surface; wherein the radiator is located on the first dielectric plate, and wherein the first metal layer is located on the third dielectric plate surface or the fourth dielectric plate surface.

3. The FSS system of claim 2, wherein the receiving assembly further comprises:
a third dielectric plate comprising:
a fifth dielectric plate surface; and
a sixth dielectric plate surface opposite to the fifth dielectric plate surface; and
a fourth dielectric plate, wherein the third dielectric plate and the fourth dielectric plate are stacked and spaced apart, wherein the fourth dielectric plate comprises:
a seventh dielectric plate surface; and
an eighth dielectric plate surface opposite to the seventh dielectric plate surface, wherein the sixth dielectric plate surface is opposite to the seventh dielectric plate surface; wherein the receiver is located on the fourth dielectric plate, and wherein the second metal layer is located on the fifth dielectric plate surface or the sixth dielectric plate surface.

4. The FSS system of claim 1, wherein the metal shielding member is a shielding frame comprising one or more cavities, a first shielding frame side surface, and a second shielding frame side surface, wherein the feed network component is housed within the cavity, and wherein the first shielding frame side surface and the second shielding frame side surface comprise openings.

5. The FSS system of claim 3, wherein the transmission assembly comprises at least one substrate comprising a first substrate end, a second substrate end, a first substrate surface, and a second substrate surface, wherein the first substrate end penetrates the second dielectric plate and the first dielectric plate, wherein the second substrate end of penetrates the third dielectric plate and the fourth dielectric plate; wherein the FSS system further comprises a metal sheet disposed on at least one of the first substrate surface or the second substrate surface, wherein the metal sheet comprises a first metal sheet end and a second metal sheet end, wherein the first metal sheet end is electrically connected to the receiver, and wherein the second metal sheet end is electrically connected to the radiator.

6. The FSS system of claim 5, wherein the metal sheet further comprises:
an upper metal sheet; and
a lower metal sheet, wherein there is a gap between the upper metal sheet and the lower metal sheet.

7. The FSS system of claim 6, wherein the metal sheet is disposed on the first substrate surface or the second substrate surface, wherein the gap comprises at least one horizontal gap and at least one vertical gap, and wherein the at least one horizontal gap communicates with the at least one vertical gap.

8. The FSS system of claim 6, wherein the metal sheet is disposed on the first substrate surface and the second substrate surface, and wherein along a length direction of a substrate, the gap on the first substrate surface and the gap on the second substrate surface are staggered.

9. The FSS system of claim 5, wherein the radiator comprises a radiator end that faces the first dielectric plate, wherein the radiator end has at least one first slot that is in a one-to-one correspondence with the at least one substrate, wherein the first substrate end of each substrate is inserted into the first slot corresponding to the substrate, wherein the receiver comprises a receiver end that faces the fourth dielectric plate, wherein the receiver end has at least one second slot that is in a one-to-one correspondence with the at least one substrate, and wherein the second substrate end of each substrate is inserted into the second slot corresponding to the substrate.

10. The FSS system of claim 3, wherein the first metal layer is disposed on the third dielectric plate surface, and wherein the feed network component is disposed on the fourth dielectric plate surface, and wherein the transmission assembly penetrates the cavity.

11. The FSS system of claim 10, wherein the metal shielding member is a shielding tube comprising a first shielding tube end and a second shielding tube end, wherein the first shielding tube end is connected to the second dielectric plate and the first metal layer, and wherein the second shielding tube end is connected to the third dielectric plate and the second metal layer.

12. The FSS system of claim 11, wherein the transmission assembly comprises at least one transmission wire comprising a first transmission wire end and a second transmission wire end, wherein the first transmission wire end passes through the shielding tube, the second dielectric plate, and the first dielectric plate to be electrically connected to the radiator, and wherein the second transmission wire end passes through the third dielectric plate and the fourth dielectric plate to be electrically connected to the receiver.

13. The FSS system of claim 1, wherein a first position of the radiator is such that an orthographic projection of the radiator onto the receiver coincides with a second position of the receiver.

14. The FSS system of claim 1, wherein the radiator and the receiver each comprises a plurality of first branches electrically connected to the transmission assembly.

15. The FSS system of claim 14, wherein the radiator and the receiver each further comprises a plurality of second branches respectively coupled to the plurality of first branches.

16. A frequency-selective surface (FSS) comprising:
a plurality of FSS systems configured to form an FSS system array, wherein each of the FSS system comprises:
a radiation assembly comprising:
a radiator configured to radiate energy to outside of the FSS system; and
a first metal layer, wherein the radiator and the first metal layer are stacked and spaced apart;
a receiving assembly spaced apart from the radiation assembly and comprising:
a receiver configured to receive the energy from a terminal; and
a second metal layer, wherein the receiver and the second metal layer are stacked and spaced apart, and wherein the first metal layer and the second metal layer are located between the radiator and the receiver;
a transmission assembly comprising:
a first transmission assembly end passing through the first metal layer to be electrically connected to the radiator; and
a second transmission assembly end passing through the second metal layer to be electrically connected to the receiver, wherein the transmission assembly is configured to transmit the energy from the receiver to the radiator and wherein the radiation assembly, the receiving assembly, and the transmission assembly are stacked and spaced apart;
a feed network component; and
at least one metal shielding member comprising a cavity, wherein the at least one metal shielding member and the feed network component are located in the space, wherein the at least one metal shielding member is configured to shield at least one of the transmission assembly or the feed network component, and wherein the transmission assembly or the feed network component is housed within the cavity wherein the FSS system array comprises a plurality of shielding frames, and wherein shielding frames between the plurality of FSS systems are independently disposed or at least partially shared.

17. An antenna comprising:
a frequency selective surface (FSS), wherein the FSS comprises a plurality of FSS systems to form an FSS system array, wherein an FSS system comprises:
a radiation assembly comprising:
a radiator configured to radiate energy to outside of the FSS system; and
a first metal layer, wherein the radiator and the first metal layer are stacked and spaced apart;
a receiving assembly spaced apart from the radiation assembly and comprising:
a receiver configured to receive the energy from a terminal; and
a second metal layer, wherein the receiver and the second metal layer are stacked and spaced apart, and wherein the first metal layer and the second metal layer are located between the radiator and the receiver;
a transmission assembly comprising:
a first transmission assembly end passing through the first metal layer to be electrically connected to the radiator; and
a second transmission assembly end passing through the second metal layer to be electrically connected to the receiver, wherein the transmission assembly is configured to transmit the energy from the receiver to the radiator, and wherein the radiation assembly, the receiving assembly, and
the transmission assembly are stacked and spaced apart; and
feed network component; and
at least one metal shielding member comprising a cavity, wherein the at least one metal shielding member and the feed network component are located in the space, wherein the at least one metal shielding member is configured to shield at least one of the transmission assembly or the feed network component, and wherein the transmission assembly or the feed network component is housed within the cavity, wherein the FSS system array comprises a plurality of shielding frames, and wherein the shielding frames between the plurality of FSS systems are independently disposed or at least partially shared; and
a first antenna array located above the FSS and is electrically connected to the feed network component.

18. The antenna of claim 17, further comprising a second antenna array configured to radiate a second electromagnetic wave, wherein the first antenna array is configured to radiate a first electromagnetic wave, and wherein the second antenna array is located below the FSS, and wherein the FSS is configured to transmit the second electromagnetic wave and reflect the first electromagnetic wave.

19. The antenna of claim 18, wherein a first operating frequency band of the first antenna array is different from a second operating frequency band of the second antenna array.

20. A communication device, comprising:
a radio frequency module; and
an antenna comprising:
a frequency selective surface (FSS), wherein the FSS comprises a plurality of FSS systems to form an FSS system array, wherein each of the FSS system comprises:
a radiation assembly comprising:
a radiator configured to radiate energy to outside of the FSS system; and
a first metal layer, wherein the radiator and the first metal layer are stacked and spaced apart;
a receiving assembly spaced apart from the radiation assembly and comprising:
a receiver configured to receive the energy from a terminal; and
a second metal layer, wherein the receiver and the second metal layer are stacked and spaced apart, and wherein the first metal layer and the second metal layer are located between the radiator and the receiver;
a transmission assembly comprising:
a first transmission assembly end passing through the first metal layer to be electrically connected to the radiator; and
a second transmission assembly end passing through the second metal layer to be electrically connected to the receiver, wherein the transmission assembly is configured to transmit the energy from the receiver to the radiator, and wherein the radiation assembly, the receiving assembly, and the transmission assembly are stacked and spaced apart; and
a feed network component;
a transmission wire connecting the feed network component to the radio frequency module; and
at least one metal shielding member comprising a cavity, wherein the at least one metal shielding member and the feed network component are located in the space, wherein the at least one metal shielding member is configured to shield at least one of the transmission assembly or the feed network component, and wherein the transmission assembly or the feed network component is housed within the cavity, and wherein the FSS system array comprises a plurality of shielding frames, and wherein the shielding frames between the plurality of FSS systems are independently disposed or at least partially shared, and
an antenna array located above the FSS and electrically connected to the feed network component in the FSS system.
